(19) United States
(12) Patent Application Publication
(10) Pub. No.: US 2002/0055798 A1
(43) Pub. Date: May 9, 2002

(54) Method of assembly instruction and computer readable medium containing the same

(76) Inventor: Bryan T. Haye, League City, TX (US)

Correspondence Address: Carol M. Nielsen, GARDERE WYNNE SEWELL LLP, Patent Section (H), 1601 Elm Street, Suite 3000, Dallas, TX, 75201, US

(21) Appl. No.: 09/994,001

(22) Filed: Nov. 6, 2001

Related U.S. Application Data
(60) Provisional application No. 60/246,411, filed on Nov. 7, 2000.

(51) Int. Cl. G06F 19/00; B23Q 17/00

(52) U.S. Cl. 700/95; 29/407.05

(57) ABSTRACT

A method of assembly instruction provides an easy to understand set of instructions to assemble any product. The methodology of the subject invention uses three distinct components. The first component of the methodology is a graphic or photographic description of each group of parts along with a sequential order of assembling within each group. The second component of the methodology is a written, analytical description of the parts being assembled coordinating with or to the first component. The third component is the proper marking and identification of the parts to be assembled. Together these components create a systematic methodology for the end user to follow. The methodology is also suitable for use in a computer readable medium.

### CROSS REFERENCE TO RELATED APPLICATION

This application is based on Provisional Application Serial No. 60/246,411 filed Nov. 7, 2000.

### BACKGROUND

The economy of the twenty first century has created a high demand for products to be manufactured and provided to the end user unassembled in some sort of a consolidated packaging. The manufacturers are forced by economies of scale to package their products in the most confined manner possible to decrease their size for shipment. Combined with the Internet explosion and the purchasing of products on line, end users are assembling more products than ever in our history. End users are contributing more and more to the manufacturing process with little or no help from the manufacturers.

Being a consumer of unassembled products in the United States has become increasingly difficult. The instructions provided are often written by the engineers who designed and, therefore, intricately know the product. Assumptions are made in preparing the instructions that consumer may or may not be able to overcome. The average person with limited or no knowledge of the product will have the task of assembling a product with an instruction set that is too complex or lacks the specificity and completeness necessary for the unskilled person to assembly the product. At the very least, the assembly of products is very time consuming.

Many consumer products, ranging from a simple child's toy to very complicated electronic devices, are sold unassembled. In each instance, the customer opens the box containing the various parts to be assembled and immediately looks for a set of instructions that teach how to assemble the product. Unfortunately, more often than not, the customer spends countless hours in trying to decipher and understand the set of instructions. This deciphering of the instructions is further complicated if the instructions are incomplete, difficult to follow, translated from a foreign language or are provided in multiple languages. More often than not, the consumer has no idea as to what the end product looks like as the packaging or instructions does not provide an accurate depiction of the final product. As a result, the consumer must telephone the technical support line for assistance in assembling the parts. Worse yet, the consumer may refuse to purchase another unassembled product from that manufacturer knowing what a nightmare it may become.

At the intersection of limited product knowledge and complex or limited assembly instructions, most consumers find themselves dissatisfied with the product before it is in use. In addition the manufacturer incurs additional costs associated with the end user calling, phoning, or faxing for additional help or commonly known as product support or technical support. Ultimately, this leads to consumer dissatisfaction, experienced technical support, higher prices, and lower return rates to the retailer and manufacturer.

A need exists, therefore, for a method of assembly instruction applicable for use with virtually any product that standardizes the assembly and the manner in which the assembly instruction is taught and provided.

### SUMMARY OF INVENTION

The present invention relates to a method of standardizing instruction sets for the assembly of consumer products. The method of the present invention utilizes both visual and analytical instructions for the assembly process. Both aspects are designed to reduce the amount of time needed to learn the process of assembly for a particular product by having available to the end user a complete instruction set that the average lay person can comprehend. The methodology of the present invention has universal application and can be used to provide instruction sets for any product that needs assembling. The resulting standardized set of instruction may be in paper form or in electronic form and also may be provided via video. Also, the instruction may be created using logic and algorithms stored in computer readable media.

The present invention is a method of assembly instruction having the following components: (1) graphic illustration of all the parts to be assembled or each individual part, (2) textual or narrative description of the parts to be assembled, and (3) systematic identification of the parts to be assembled. The present invention uses all three components in a unique combination to provide a method to generate standardized assembly instructions sets.

The subject method comprises the following steps: a) select parts to be assembled in a subassembly based on a logical sequence, pattern, order or arrangement of assembly; b) identify each part numerically wherein each part shall contain a part number identifier and a subassembly identifier number; c) provide labeling containing the part number identifier and the subassembly identifier for each part; d) provide an illustration with the part numbers of the subassembly depicting how each part fits into the subassembly by part number identifier and subassembly identifier;e)provide a written description of how the parts are to be assembled in the subassembly by part number identifier and subassembly identifier; f) repeat steps a-e until all parts to be assembled have been grouped into a subassembly; g) provide an illustration of the product wherein each subassembly is assembled by sequential subassembly identifier number; and h) provide a written description of how the subassemblies are assembled.

As described below, the methodology of the present invention may be used in connection with a computer readable medium program or on a computer readable storage device. The instruction sets may be contained in a memory for storing data for access by an application program being executed on a data processing system. A data processing system executing an application program and containing a database having the instruction sets used by the application program is also within the scope of the invention. Hence, the methodology of the present invention may be suitable for software applications and available in CD Rom, diskette, tapes or any electronic storage medium. Likewise, it may be stored in a language that is accessible to the user via the Internet.

The user may also be provided with a website address in which he is able to access to any updates to the assembly instruction. The updates can be directly downloaded from the site. On the internet, a consumer may also be able to receive technical and product support, and to browse and search through the site for related topics, answers to tough questions, etc. The site may further allow consumers to download product updates, order parts, view parts lists or view an exploded diagram.

### DETAILED DESCRIPTION

As shown in the attached drawings, in the preferred embodiment of the subject invention, a first section of the assembly instruction set contains a place for the manufacturer to provide space for the manufacturer's name, model number description and logo or other trademarks or identifiable advertising used by the manufacturer. The lower portion of the first page will provide for documentation and or trademarks of the writer of the instruction set and state the purpose of the instruction set.

A second section of the written assembly instructions describes major points, techniques, or cautions that should not be avoided or should specifically be adhered to during the assembly process. This section is used also for more knowledgeable users to have a set of cliff notes to not forget major aspects of the assembly process.

A third section is the written assembly instructions. The instructions describe how to unpack the parts to be assembled according to the identifiable markings, both part number identifier and sub-assembly identifier, contained on each individual part or package of parts. The identifiable markings are sequentially ordered and combined in groups regardless of the order the parts and are packaged in manufacturer's shipping containers. An example of subassembly numbers is when all parts are marked or stamped as “A” and therefore, need to be grouped with all other “A” parts or packages. Another example are parts and or packages having subassembly numbers 1, 2, 3, 4 to be grouped together with parts and or packages 5, 6, 7, 8. The groupings of the parts and packages will then coordinate and correspond to the sequentially identified steps to assemble the product.

A fourth section of the written assembly instruction contains the methodology of the physical assembly process of the manufacturer's product. Each grouping or subassembly is noted by a separate identification, for example, A-X (where X is any number 1 through infinity). The assembly instructions contain as many subassemblies as necessary to complete the assembly of the product.

The fifth section contains illustrations. In this preferred embodiment, the illustrations are exploded diagrams of all of the parts provided by the manufacturers to the end users. Each of the parts is identified by the subassembly identifier and part number identifier. The manufacturer's part number may be used as the part number or may be an additional number applied to each part. The purpose of this section is to enable the end user to identify parts that have either been erroneously marked by the manufacturer or where identifying markings have been lost by other means such as labels falling off of the packages.

The sixth section of the written instructions contains information needed by the end users, if necessary to obtain technical support for the product that the end user is assembling. The section will be labeled in the beginning of the section as “Support”. The information contained on these pages are provided and or agreed to by the manufacturer.

The methodology of the present invention contains three distinct components. The first component of the method of assembly instruction is a visual image of the parts to be assembled. The parts as marked with a part number identifier and a subassembly identifier are illustrated. The visual illustrations are provided by subassembly identifier, each part number identifier sorted into and by subassembly identifier. The second component of the method of assembly instruction is an analytical or written description of the individual visual frame or step required to capture accurately and with specificity in easy to understand terms the order of assembly. Like the illustrations, these written descriptions are provided and organized by subassembly identifier. The part number identifiers are sorted by subassembly identifier. The third component of the method of assembly instruction is the accurate marking of the parts and subassemblies. Each part is marked by subassembly identifier and a part number identifier. Preferably, each part is also physically placed in packaging by subassembly identifier.

The purpose of the subject invention is to uniformly coordinate the stages of the assembly process and reduce the time and learning process needed by the end user to assemble the manufacturer's product. The information contained in each instruction set, however, is unique to the individual product being assembled. Immediately below are some examples of how a consumer may utilize the method of the present invention.

In a first embodiment of the subject invention, the customer opens a box and finds a set of instructions. The set of instructions have been generated by the software of the present invention. The set of instructions is easy to follow because it is organized in a logical fashion using examples and pictures.

In a second embodiment of the subject invention, the customer opening a box and finds a CD or diskette that contains the set of instructions. The instructions are provided via software. The customer follows a set of protocols led by the software. The set of instructions may contain a set of hyperlinks that link to the particular subject in question. If the customer does not understand something or wants to learn more about a particular topic, he will simply click on the hyperlink. The hyperlink leads him to the topic he requested. Additionally, the customer may also hyperlink directly to a live technical support by email or the Internet.

In yet a third embodiment of the present invention, the customer opens a box and finds a piece of paper that instructs him to log onto the Internet to access the set of assembly instructions. The customer logs on the Internet to a website that has been dedicated for facilitating the present invention, e.g., www.afi.com, or www.assemblyfriendly.com. Upon successful entry to the website, the customer will enter the product's tag number or name into a window provided. He may also be prompted to enter other information pertaining to the purchase, e.g., place, date, etc. Afterwards, he views the instructions for the product purchased. Like the second scenario, the site will provide him with hyperlinks to guide him into the topics of interest. The site also provides a hyperlink that will directly connect him to a live technical support that can help him with the assembly process. The site further allows him to order parts that may be missing or additional parts to the product. He may also be able to purchase the product or other products online through the site.

In a fourth embodiment of the invention, the customer plays a video either via a storage medium or over the Internet explaining the assembly process and what the end product looks like using the methodology described above.

Finally, in a fifth embodiment, the supplier logs on the Internet to the website and bids to supply the parts for the products available on the site via the use of the part number identifier and/or subassembly identifier.

The present invention includes the availability to create and maintain electronic, standardized instruction sets for assembly of consumer products. Such instructions are created and maintained via a combination of software programs and a unique database structure. The first step in generating a set of instructions includes the identification of a file name used for a particular product. The same file is also used to store information that may be provided by the user.

A database may be generated as follows:

at least one object linking and embedding type data field to store illustrations with their accompanying documents

at least one text field to store the textual description of the assembly instructions;

at least one object linking and embedding type field to store the illustration of the part or diagram of the part

at least one object linking and embedding type field to store the textual description of the part

at least one object linking and embedding type field to store the part number and the total number of the parts shipped with the product

at least one field to store the retail price of the part;

at least one field to store the manufacturer's cost of the part; and

at least one field for maintaining referential integrity and storing procedural calls for programming purposes. The user enlarges the space needed in the database, if necessary, to include the ability of linking parts to a subassembly and combining the subassemblies to form the product.

In addition, a splash screen may be used that describes ownership rights, licensing information, logo, application version, intellectual property rights protecting the product, and credits to designers and creators of the application. After the splash screen, a variety of menu bars to perform specific tasks relating to formatting and designing graphics may also be displayed along with a description of the assembly process.

Once the file has been created, a title page having an upper portion allowing the manufacturer to draw, describe, illustrate the product is opened. By activating the area, the user is prompted to either import a design or create a new design. If new design is selected, the program provides a list of designers/illustrators registered, or allows for retrieval of illustrations that are stored in the database. When finished with the title design, the user can save the title page. The title page design may be saved to the object linking and embedded field within the file alias and underlying table.

The next form or computer screen is labeled Hot Tips. The section contains tips for assembling the parts. For example, “make sure to assemble the product in a padded surface, Phillips head screw driver makes the assembly process easy”. This section is available for text and diagramming. The form itself is relatively simple in nature, allowing for the import or export of text, imaging, diagramming, or anything else the manufacturer may find critical to the ease of assembly of the product and to a successful assembly. The manufacturer/user at this point may save the instruction set for this Hot Tips page to the corresponding record in the underlying table.

The sequencing of forms relating to the assembly process may begin at this point. The forms can be created by the user or a wizard that generates an automatic sequencing of forms or screens. The wizard may also prompt the user through the assembly instruction process. The sequencing of the forms may also be customized by the user in accordance to the user's desires. However, the protocols of the instruction set may remain unaffected.

In another embodiment, a parts list is provided which describes the parts used in the assembly process and creates part number identifiers. A diagram of the parts is also available. The diagram may be created from any illustrator that is associated with the user's machine or an illustrator that is built in the application. The diagrams may be displayed three dimensionally depending on the complexity of the parts. The diagrams may also be rotated into different positions. As each part is entered, the user will be prompted to continue adding records of parts until all the parts used to assemble the product have been entered. At this point, the user closes the form or screen and has finished the parts listing.

An Exploded Diagram may also be created via the software and the database of the subject invention. An illustrator must be used to draw or to import an existing exploded diagram from another source. The illustrator used for creating the exploded diagram may be interactive or Active X based technologies. Internal illustrator, i.e., illustrator that comes with the methodology, may also be used. When the internal illustrator is used in the new diagram, a menu/tool bar based on the parts list (which was previously inputted) is available for use. The user may drag and drop any part from the parts list on the tool bar on to the internal illustrator. The parts may be displayed as icons on the tool bar. The parts may be rotated, enlarged or made smaller to fit the specific diagram. This keeps the user from having to draw each part from scratch each time a part need to be displayed. Whenever the illustrator is active, the parts list as displayed on the tool bar is available for the user to drag and drop the parts listed in the parts list. At any time, the user may also go back to the parts list and either add more parts or modify existing ones. This allows the manufacturer assembly instructions to be quickly revised as the manufacturer changes its products.

Next, the methodology prompts the user to begin the actual assembly instruction. The subassembly is generated by importing illustrations or creating the illustration from scratch, i.e., new. A screen may be split for text to explain an illustration provided above. The user may import or create the text from scratch, i.e., new. The illustration and written description may be saved to a single record which coordinates the two (illustration and written description) for printing in the final stages. Changes are saved and the process terminated, or if another set of instructions is required to continue. After the first time, the program creates the same as described earlier in this paragraph with the exception that the form will be sequentially labeled. The user may be able to create as many steps as necessary to complete the assembly of the product.

The methodology continues to provide a new record for another set of instructions, that is, markings including subassembly identifier and associated part numbers, illustration and written description until all parts are accounted for and the methodology is terminated.

The manufacturer has the ability to describe the assembled products final points of use, or direct the user to quickly get the highlights of getting the product to a functioning stage, i.e., how to quickly use the basic functions of the product. Space is available for the manufacture/user to insert/import this type of information. Either diagrams or text may be imported or created in this area. When finished, the user is prompted to save the changes made and continue to the printing stages of the instructions set. For example, “setting the barbeque pit on high for 30 minutes prior to cooking”, etc.

The final process for the user is to indicate the printing layout of the assembly instructions to be placed in the products packaging. The user is allowed to condense the illustrations and text down smaller than standard or enlarge them. The user may modify the way the instruction set is being printed, such as printing the front and back of a single piece of paper, thus allowing the user for manual set up of single sided printers to skip pages and reprint on the back side, etc. The user may also determine the number of pages required for each set of instructions. The specific order of the information to be printed is typically ordered having the title page as the first section, the hot tips as the second section, instruction pages (as many needed to complete the assembly process) as the third section, the section “up and running” as the fourth section, the parts list as the fifth section, and finally the exploded diagram as the sixth section. The present invention, however, is not limited in the way the set of instructions is ordered. The user may manually change the order according to the product or user's wishes.

At this point in the methodology and application, the manufacturer has completed the assembly instructions for the product.

The user may also be provided with a website address in which he is able to access to the updates to the software/program. He may also be able to download the updates directly from the site. At the web site, he may also be able to receive technical and product support. The user may also be able to browse and search through the site for related topics, answers to tough questions, etc. The site may further allow consumers to download product updates, order parts, view parts list, or view the exploded diagram.

The application may be designed for any language in the world. It may also be compatible with any computer, e.g., PC, Mac, Apple, etc. It may be written using any operating system, e.g., windows, and using any code builder, e.g., C+, C++, Visual Basic. The present invention is not limited to any software language, i.e., the application is written in a manner that any user can open and use it.

What is claimed

1. A method of assembling a product having at least two parts comprising the steps of:
defining a first subassembly based on a logical sequence, pattern, order or arrangement of parts;
indexing parts of said first subassembly;
providing markings for each part of said first subassembly, wherein said markings include a part number identifier and a first subassembly identifier;
providing a first illustration for said first subassembly, wherein said first illustration shows each connection between parts of said first subassembly by using said part number identifier and said first subassembly identifier;
providing a first written description for the first subassembly, wherein said first written description describes each connection between parts of said first subassembly by using said part number identifier and said first subassembly identifier;
repeating steps a-e for each additional subassembly required to connect all parts of the product;
providing a second illustration illustrating a sequential connection of each subassembly by subassembly identifier number; and
providing a second written description describing the sequential connection of each subassembly by subassembly identifier number.

2. An assembly instruction system for assembling a product having more than one part comprising:
a plurality of markings for each part of the product to be assembled together, said plurality of markings including a part number identifier and a subassembly identifier, wherein said subassembly identifier corresponds to a subassembly comprising a logical sequence, pattern, order, arrangement, or grouping of at least one part;
a first illustration for each subassembly wherein said first illustration shows how each said part number identifier connects with another part number identifier within said subassembly identifier;
a first written description for each subassembly wherein said first written description describes how each said part number identifier connects with another part number identifier within said subassembly identifier;
a second illustration comprising a drawing containing each said subassembly identifier in sequential order and depicting the connection between said subassembly identifiers; and
a second written description comprising a written narration by subassembly identifier in sequential order for each connection of each subassembly to another subassembly.

3. A computer-readable medium containing a data structure for creating and storing assembly instructions for a product comprising:
a first portion identifying a part number identifier;
a second portion identifying a subassembly identifier;
a third portion identifying each said part number identifier associated with each subassembly identifier;
a fourth portion identifying a written description of each subassembly identifier;
a fifth portion identifying an illustration of parts of each subassembly identifier;
a sixth portion identifying a second written description containing a written narration of the sequential connection of the subassembly identifiers; and
a seventh portion identifying a second illustration containing an illustration showing the sequential connection of the subassembly identifiers.

4. A computerized method of assembling a product having more than one part comprising:
providing a plurality of markings for each part of the product to be assembled together, said plurality of markings including a part number identifier and a subassembly identifier, wherein said subassembly identifier corresponds to a subassembly comprising a logical sequence, pattern, order, arrangement, or grouping of at least one part; and
employing said parts number identifiers as sorted by said subassembly identifiers to assembly the product.

5. A computerized method of creating assembly instructions for a product having at least two parts comprising the steps of:
preparing an illustration of a segment of the product based on a logical sequence, pattern, order or arrangement of parts;
correlating said illustration with a subassembly identifier;
linking said part in said segment with a part number identifier and said subassembly identifier;
creating a first written description, said written description correlating each said part number identifier with another part number identifier within said subassembly identifier;
repeating steps a-c for each additional illustration required to connect all parts of the product; and
preparing a second illustration showing the sequential connection of each said subassembly identifiers to complete the assembly of the product.

6. A computer-readable medium containing instructions to put together a product having more than one part, by
designating each part by a part number identifier and a subassembly identifier;
illustrating each subassembly identifier;
describing each subassembly identifier through written narrative; and
combining each subassembly identifier sequentially to complete product assembly.
